(19) United States
(12) Patent Application Publication
(10) Pub. No.: US 2014/0079010 A1
(43) Pub. Date: Mar. 20, 2014

(54) Method and system for feeding back channel measurement information

(71) Applicants: Nan Li, Shenzhen (CN); Kaiying Lv, Shenzhen (CN); Bo Sun, Shenzhen (CN); Jing Jiang, Shenzhen (CN); Li Zhang, Shenzhen (CN)

(72) Inventors: Nan Li, Shenzhen (CN); Kaiying Lv, Shenzhen (CN); Bo Sun, Shenzhen (CN); Jing Jiang, Shenzhen (CN); Li Zhang, Shenzhen (CN)

(73) Assignee: ZTE CORPORATION, Shenzhen, Guangdong (CN)

(21) Appl. No.: 14/115,482

(22) PCT Filed: Feb. 28, 2012
(86) PCT No.: PCT/CN2012/071742

§ 371 Date: Nov. 4, 2013

(30) Foreign Application Priority Data
May 6, 2011 (CN) 2011101166689

(51) Int. Cl. H04B 7/06; H04W 72/04

(52) U.S. Cl. CPC H04B 7/0632; H04W 72/0446
USPC 370/329

(57) ABSTRACT

The disclosure provides a method and system for feeding back channel measurement information. The method includes: a receiving station receives a control frame for a channel measurement from a sending station, and sends channel measurement information to the sending station; the sending station correctly receives the channel measurement information or a part of the channel measurement information to obtain a valid response frame responding to the control frame for the channel measurement. Through the above solutions, if the sending station only correctly receives a part of the channel measurement information, the sending station does not consider this transmission is failed but consider that the valid response frame responding to the control frame for the channel measurement is obtained, so as to avoid unnecessary withdraw and retransmission, thereby saving bandwidth resources.

### TECHNICAL FIELD

The disclosure relates to the field of a Wireless Local Area Network (WLAN), in particular to a method and system for feeding back channel measurement information.

### BACKGROUND

With the development of a WLAN in the field of a wireless network at present, a requirement for WLAN coverage is growing, and a requirement for throughput becomes higher. A set of WLAN technical standards (such as 802.11a, 802.11b, 802.11g) is defined in an Institute for Electrical and Electronic Engineers 802.11 (IEEE802.11) standard; then other subsequent task groups improve the conventional IEEE802.11 standard, for example: a 802.11n task group proposes a High Throughput (HT) request to support data rate up to 600 Mbps, a 802.11ac task group further proposes a Very High Throughput (VHT) concept to improve data rate up to 1 Gbps by using a wider channel bandwidth.

In the IEEE802.11 standard, an Access Point (AP) and a plurality of STAtions (STAs) which are non-AP and associated with the AP form a Basic Service Set (BSS). Four operation modes are defined in the IEEE802.11 standard: Distributed Coordination Function (DCF), Point Coordination Function (PCF), Enhanced Distributed Channel Access (EDCA) and Hybrid Coordination Function Controlled Channel Access (HCCA) modes. The DCF and EDCA modes both adopt a Carrier Sense Multiple Access (CSMA) mechanism with a function of Collision Avoidance (CA), so as to allow a plurality of STAs to share wireless channels. However, a Difference between the two modes is that the EDCA mode is applied to frame transmission having Quality of Service (QoS) requirements.

In the WLAN, there are four Access Categories (ACs): AC_VO, AC_VI, AC_BE and AC_BK. There are mapping relationships between User Priority (UP) of a Medium Access Control (MAC) Service Data Unit (MSDU) and the above four ACs. Each of the ACs corresponds to a set of EDCA parameter sets. And thus a radio frame having specific priority requirements adopts a parameter set contend channel of an AC corresponding to the UP, so as to obtain a Transmission Opportunity (TXOP).

In the related art, a radio frame may be transmitted between the AP and the STA by using a multi-antenna and beam forming technique. For example, when performing downlink Multiple Input Multiple Output (MIMO) transmission, the AP may inform the STA to perform a channel measurement; after the measurement, the STA feeds back a measurement result to the AP; and the AP calculates a guide matrix based on the measurement result so as to optimize receipt of a receiving end. Generally, a part sending information by using the guide matrix is called a channel measurement information request part (beamformer), and a receiving part is called a channel measurement information feedback part (beamformee). The implement of this process is shown in FIG. 1, which probably includes: the beamformer sends a Null Data Packet Announcement (NDPA) frame for informing the beamformee to perform a channel measurement; after sending the NDPA frame completely, the beamformer waits a Short InterFrame Space (SIFS) and then sends a Null Data Packet (NDP) frame. The NDPA frame includes information of one or more beamformees which perform a channel measurement, and a first beamformee in the NDPA frame (such as beamformee 1 shown in FIG. 1) waits an SIFS and then sends a channel measurement feedback report frame (VHT Compressed Beamforming frame) after receiving the NDP frame; if the NDPA frame includes information of a plurality of beamformees, each beamformee except the first beamformee (such as beamformee 2 and beamformee 3 shown in FIG. 1) feeds back a channel measurement feedback report after receiving a sounding poll frame from the beamformer.

In the related art, the waiting an SIFS and then sending a VHT Compressed Beamforming frame is considered as a valid response to the NDPA frame. When the length of the VHT Compressed Beamforming frame is greater than the maximum length of an MAC Protocol Data Unit (MPDU), the VHT Compressed Beamforming frame needs to be divided to a plurality of segments (up to 8 segments), and each segment includes information for indicating the number of retained segments and whether the segment itself is a first segment. Then all the segments are sent by using one Aggregate MPDU (A-MPDU). However, when a plurality of segments are sent by using one A-MPDU, if the beamformer only correctly receives a part of segments and does not make any processing, this case is only considered as transport failure, unnecessary withdraw and retransmission will be caused, thereby wasting bandwidth resources. Particularly, when the NDPA frame is a first frame of the TXOP, if it is considered as transport failure, the obtaining TXOP will fail, and the beamformer has to withdraw and contend channels again, thereby reducing network throughput.

### SUMMARY

Accordingly, the main purpose of the disclosure is to provide a method and system for feeding back channel measurement information, so as to avoid unnecessary withdraw and retransmission, thereby saving bandwidth resources.

To this end, the technical scheme of the disclosure is realized as follows.

A method for feeding back channel measurement information includes:

a receiving station receives a control frame for a channel measurement from a sending station and sends channel measurement information to the sending station;

the sending station correctly receives the channel measurement information or a part of the channel measurement information to obtain a valid response frame responding to the control frame for the channel measurement.

The control frame for the channel measurement may include: an announcement frame for the channel measurement, and/or a Null Data Packet (NDP) frame, and/or a channel measurement information sounding poll frame.

The announcement frame may be a Null Data Packet Announcement (NDPA) frame which includes identifier information of one or more receiving stations which need to perform the channel measurement; and the NDP frame may be used by the receiving station to perform the channel measurement.

When the control frame for the channel measurement is used to initiate a Transmission Opportunity (TXOP), and when the sending station correctly receives the channel measurement information or the part of the channel measurement information from the receiving station, the TXOP may be obtained successfully.

The part of the channel measurement information may include at least one segment of the channel measurement information.

The method may also include:

the sending station sends a channel measurement information sounding poll frame to the receiving station to request the receiving station to perform retransmission, if the sending station determines that all segments from the receiving station are not correctly received; and the receiving station retransmits a segment which is not correctly received or all the segments in the channel measurement information after receiving the channel measurement information sounding poll frame.

The valid response frame may be a channel measurement feedback report frame.

The sounding poll frame may include information for indicating which segment needs to be retransmitted, or indicating all segments need to be retransmitted.

The sending a sounding poll frame to the receiving station to request the receiving station to perform retransmission may include: the sending station sends the sounding poll frame to the receiving station to request the receiving station to retransmit a first segment when determining that only the first segment is not correctly received;

the sending station sends the sounding poll frame to the receiving station to request the receiving station to retransmit a segment which is not received correctly when determining that the first segment is correctly received;

the sending station waits a PIFS and then sends the sounding poll frame to the receiving station to request the receiving station to retransmit all segments when determining that none of segments are not received correctly; and

the sending station waits an SIFS and then sends the sounding poll frame to the receiving station to request the receiving station to retransmit the segment which is not received correctly when determining that a part of segments is not received correctly.

Another aspect of the disclosure provides a system for feeding back channel measurement information, which includes:

a sending station configured to send a control frame for a channel measurement to a receiving station; and to correctly receive channel measurement information or a part of the channel measurement information from the receiving station to obtain a valid response frame responding to the control frame for the channel measurement; wherein the part of the channel measurement information includes at least one segment of the channel measurement information; and

the receiving station configured to receive the control frame for the channel measurement from the sending station, and to send the channel measurement information to the sending station.

The sending station may be configured, when all segments from the receiving station are not correctly received, to send a channel measurement information sounding poll frame to the receiving station to request the receiving station to perform retransmission; and the receiving station may be correspondingly configured to receive the sounding poll frame and to retransmit a segment which is not correctly received or all the segments in the channel measurement information.

When the control frame for the channel measurement is used to initiate a Transmission Opportunity (TXOP), and when the sending station correctly receives the channel measurement information or the part of the channel measurement information from the receiving station, the TXOP may be obtained successfully.

The sending station may be an Access Point (AP), and the receiving station may be a STAtion (STA) which is of a non-AP; and

a number of the receiving station is one or more.

According the above solutions, the receiving station receives the control frame for the channel measurement from the sending station and sends channel measurement information to the sending station; the sending station receives all or a part of the channel measurement information to obtain a valid response frame responding to the control frame for the channel measurement. Through the above solutions, if the sending station only correctly receives a part of the channel measurement information, the sending station does not consider this transmission is failed but consider that the valid response frame responding to the control frame for the channel measurement is obtained, so as to avoid unnecessary withdraw and retransmission, thereby saving bandwidth resources.

### BRIEF DESCRIPTION OF THE DRAWINGS

FIG. 1 shows a diagram of a frame exchange sequence in conventional channel measurement;

FIG. 2 shows a flowchart of a method for feeding back channel measurement information according to the disclosure;

FIG. 3 shows a structure diagram of a system for feeding back channel measurement information according to the disclosure; and

FIG. 4 shows a diagram for transmitting segments according to the disclosure.

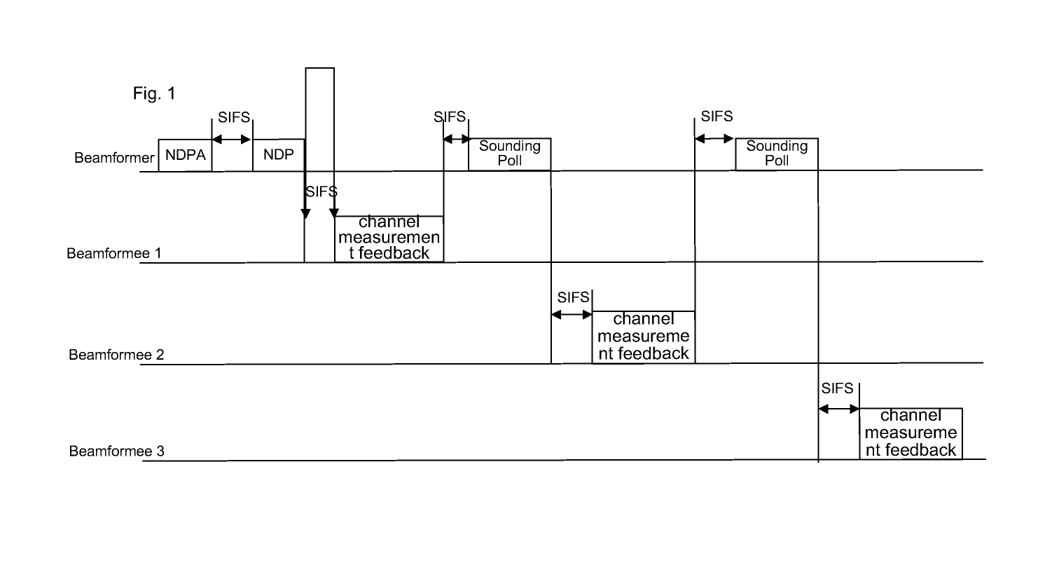

### DETAILED DESCRIPTION

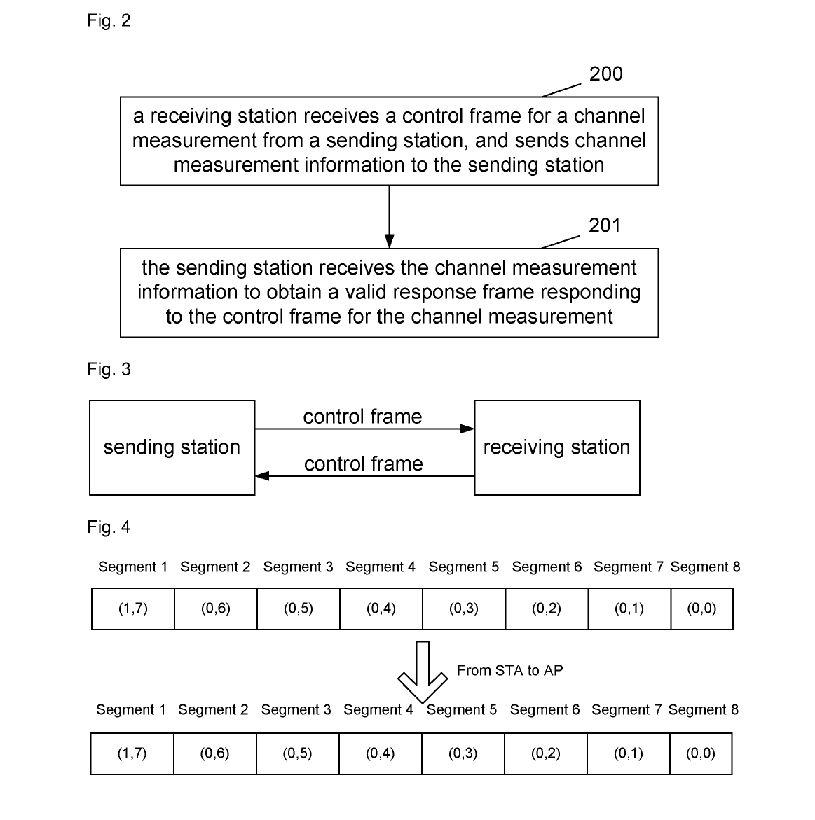

FIG. 2 shows a flowchart of a method for feeding back channel measurement information according to the disclosure. As shown in FIG. 2, this method includes the following steps.

Step 200: a receiving station receives a control frame for a channel measurement from a sending station, and sends channel measurement information to the sending station.

In this step, the control frame for the channel measurement includes: an announcement frame for the channel measurement, and/or a NDP frame, and/or a channel measurement information sounding poll frame.

The announcement frame for the channel measurement is a NDPA frame. The announcement frame includes identifier information of one or more receiving stations which need to perform the channel measurement. The NDP frame is used by the receiving station to perform the channel measurement.

Step 201: the sending station receives the channel measurement information to obtain a valid response frame responding to the control frame for the channel measurement.

In this step, the sending station obtains the valid response frame responding to the control frame for the channel measurement includes: the sending station correctly receives the channel measurement information from the receiving station; or, the sending station correctly receives a part of the channel measurement information from the receiving station, wherein the part of the channel measurement information may be at least one segment of the channel measurement information.

That is to say, in this method, if the sending station only correctly receives a part of segments, it does not consider that this transmission is failed, but considers that a valid response frame responding to the control frame for the channel measurement has been obtained, so as to avoid unnecessary withdrawn and retransmission, thereby saving bandwidth resources.

When the control frame for the channel measurement is used to initiate a TXOP, and when the sending station correctly receives all or a part of the channel measurement information from the receiving station, the TXOP is obtained successfully. After obtaining the TXOP successfully, this method of the disclosure may further include: when the sending station does not correctly receive all the segments from the receiving station, it sends the receiving station a channel measurement information sounding poll frame to request the receiving station to perform retransmission; when receiving the channel measurement information sounding poll frame, the receiving station retransmits a segment which is not correctly received or all the segments in the channel measurement information.

The disclosure also provides a system for feeding back channel measurement information corresponding to the method above, as shown in FIG. 3, the system at least includes a sending station and a receiving station.

The sending station is configured to send a control frame for a channel measurement to a sending station; and to correctly receive channel measurement information from the receiving station to obtain a valid response frame responding to the control frame for the channel measurement.

The receiving station is configured to receive the control frame for the channel measurement from the sending station, and to send the channel measurement information to the sending station.

The sending station may be configured, when all the segments from the receiving station are not correctly received, to send the receiving station a channel measurement information sounding poll frame to request the receiving station to perform retransmission. Correspondingly, the receiving station may be configured to receive the channel measurement information sounding poll frame from the sending station, and to retransmit a segment which is not correctly received or all the segments in the channel measurement information.

In the disclosure, the sending station may be an AP; there may be one or more receiving stations which may be a STA of a non-AP.

Hereinafter, the method of the disclosure will be described in detail with reference to embodiments.

### FIRST EMBODIMENT

An AP sends an STA1, STA2 and STA3 a NDPA frame to request each of them to perform a channel measurement and feed back a measurement result; the AP initiates a TXOP by using the NDPA frame including identifier information of the STA1, STA2 and STA3.

After sending the NDPA frame completely, the AP waits an SIFS and then sends a NDP frame. After the STA1, STA2 and STA3 receive the NDPA frame and the NDP frame, given that the first station STA 1 in the NDPA frame waits an SIFS after receiving the NDP frame completely, and then feeds back its channel measurement information (VHT Compressed Beamforming frame) to the AP.

Given that the length of the VHT Compressed Beamforming frame of the STA1 is greater than the maximum length of an MPDU, this VHT Compressed Beamforming frame needs to be segmented. In this embodiment, as shown in FIG. 4, the STA1 segments the VHT Compressed Beamforming frame into 8 segments which are all sent to the AP by using one A-MPDU, wherein each segment includes information for indicating the number of retained segments and whether the segment itself is a first segment, which is represented by (x, y) in FIG. 4, x is 0 or 1, where it means the segment itself is not the first segment when x is 0, and it means the segment itself is the first segment when x is 1; y is in a range of 0 to (N−1) and is used for indicating the number of retained segments, where N is the maximum number of allowable segments set by a system, herein, N=8.

After receiving the VHT Compressed Beamforming frame of the STA1, the AP determines that at least one segment of the VHT Compressed Beamforming frame is correctly received, then it is considered that the AP obtains a valid response frame responding to the NDPA frame, and that the TXOP is obtained successfully. It should be noted that it is related art to determine whether a segment is correctly received, therefore, its description is omitted.

If it is determined that there is a segment is not correctly received, the AP sends the STA1 a sounding poll frame to request it to perform retransmission, then the STA1 retransmits the segment which is not correctly received or all segments. That is to say, the sounding poll frame includes information which indicates the segment needs to be retransmitted or indicates all segments need to be retransmitted, there are many manners to carry out the above step, those skilled in the art should understand the manners which do not limit the protection scope of the disclosure. For example, if the maximum number of allowable segments set by the system is 8, when 7 segments are correctly received and x in each received segment is 0, the AP determines that only the first segment is not correctly received since the maximum number of allowable segments is 8; then the AP sends the sounding poll frame to the STA1 to request it to retransmit the first segment. If the correctly received segments include the first segment, the AP sends the sounding poll frame to the STA1 to request it to retransmit the segment which is not received correctly.

### SECOND EMBODIMENT

After receiving a TXOP, an AP sends an STA1, STA2 and STA3 a NDPA frame to request each of them to perform a channel measurement and feed back a measurement result, wherein the NDPA frame includes identifier information of the STA1, STA2 and STA3.

After sending the NDPA frame completely, the AP waits an SIFS and then sends a NDP frame. After the STA1, STA2 and STA3 receive the NDPA frame and the NDP frame, given that the first station STA1 in the NDPA frame waits an SIFS after receiving the NDP frame completely, and then feeds back its channel measurement information (VHT Compressed Beamforming frame) to the AP.

Given that the length of the VHT Compressed Beamforming frame of the STA1 is greater than the maximum length of an MPDU, this VHT Compressed Beamforming frame needs to be segmented. In this embodiment, as shown in FIG. 4, the STA1 segments the VHT Compressed Beamforming frame into 8 segments which are all sent to the AP by using one A-MPDU, wherein each segment includes information for indicating the number of retained segments and whether the segment itself is a first segment.

After receiving the VHT Compressed Beamforming frame of the STA1, the AP determines that at least one segment of the VHT Compressed Beamforming frame is correctly received, then it is considered that the AP obtains a valid response frame responding to the NDPA frame.

If it is determined that there is a segment is not correctly received, the AP sends a sounding poll frame to the STA1 to request it to perform retransmission, then the STA1 retransmits the segment which is not correctly received by the AP or all segments. For example, if the maximum number of allowable segments set by a system is 8, when 7segments are correctly received and x in each received segment is 0, the AP determines that only the first segment is not correctly received since the maximum number of allowable segments is 8; then the AP sends the sounding poll frame to the STA1 to request it to retransmit the first segment. If the correctly received segments include the first segment, the AP sends the sounding poll frame to the STA1 to request it to retransmit the segment which is not received correctly. If none of segments are received correctly, the AP waits a PCF InterFrame Space (PIFS) and then retransmits the sounding poll frame to the STA1 to request it to retransmit all the segments. If a part of segments are not received correctly, the AP waits the SIFS and then retransmits the sounding poll frame to the STA1 to request it to retransmit the segment which is not correctly received.

### THIRD EMBODIMENT

After receiving a TXOP, an AP sends a NDPA frame to an STA1, STA2 and STA3 to request each of them to perform a channel measurement and feed back a measurement result, wherein the NDPA frame includes identifier information of the STA1, STA2 and STA3.

After sending the NDPA frame completely, the AP waits an SIFS and then sends a NDP frame. After the STA1, STA2 and STA3 receive the NDPA frame and the NDP frame, the first station STA1 in the NDPA frame waits an SIFS after receiving the NDP frame completely, and then feeds back its channel measurement information (VHT Compressed Beamforming frame) to the AP; the STA2 and STA3 feed back respective channel measurement information (VHT Compressed Beamforming frame) to the AP after receiving a sounding poll frame sent by the AP.

Given that the length of the VHT Compressed Beamforming frame of the STA2 is greater than the maximum length of an MPDU, this VHT Compressed Beamforming frame needs to be segmented. In this embodiment, as shown in FIG. 4, the STA2 segments the VHT Compressed Beamforming frame into 8 segments which are all sent to the AP by using one A-MPDU, wherein each segment includes information for indicating the number of retained segments and whether the segment itself is a first segment.

After receiving the VHT Compressed Beamforming frame of the STA2, the AP determines that at least one segment of the VHT Compressed Beamforming frame is correctly received, then it is considered that the AP obtains a valid response frame responding to the sounding poll frame.

If it is determined that there is a segment is not correctly received, the AP sends the sounding poll frame to the STA2 to request it to perform retransmission, then the STA2 retransmits the segment which is not correctly received by the AP or all segments. Particularly, if the maximum number of allowable segments set by a system is 8, when 7 segments are correctly received and x in each received segment is 0, the AP determines that only the first segment is not correctly received since the maximum number of allowable segments is 8; then the AP sends the sounding poll frame to the STA2 to request it to retransmit the first segment. If the correctly received segments include the first segment, the AP sends the sounding poll frame to the STA2 to request it to retransmit the segment which is not received correctly. If none of segments are received correctly, the AP waits a PIFS and then retransmits the sounding poll frame to the STA2 to request it to retransmit all the segments. If a part of segments are not received correctly, the AP waits the SIFS and then retransmits the sounding poll frame to the STA2 to request it to retransmit the segment which is not correctly received.

### FOURTH EMBODIMENT

An AP sends a NDPA frame to an STA1 to request it to perform a channel measurement and feed back a measurement result; the AP initiates a TXOP by using the NDPA frame including identifier information of the STA1.

After sending the NDPA frame completely, the AP waits an SIFS and then sends a NDP frame. After receiving the NDPA frame and the NDP frame, the STA1 waits an SIFS after receiving the NDP frame completely, and then feeds back its channel measurement information (VHT Compressed Beamforming frame) to the AP.

After receiving the VHT Compressed Beamforming frame of the STA1, the AP determines that at least one segment of the VHT Compressed Beamforming frame is correctly received, then it is considered that the AP obtains a valid response frame responding to the NDPA frame, and that the TXOP is obtained successfully.

If it is determined that there is a segment is not correctly received, the AP sends a sounding poll frame to the STA1 to request it to perform retransmission, then the STA1 retransmits the segment which is not correctly received or all segments.

If the AP has obtained the TXOP, it sends the NDPA frame to the STA1 to request it to perform the channel measurement and feed back the measurement result, wherein the NDPA frame includes the identifier information of the STA1. After sending the NDPA frame completely, the AP waits the SIFS and then sends the NDP frame. After receiving the NDP frame completely, the STA1 waits the SIFS and then feeds back its channel measurement information (VHT Compressed Beamforming frame) to the AP. After receiving the VHT Compressed Beamforming frame of the STA1, the AP determines that at least one segment of the VHT Compressed Beamforming frame is correctly received, then it is considered that the AP obtains the valid response frame responding to the NDPA frame. If it is determined that there is a segment is not correctly received, the AP sends the sounding poll frame to the STA1 to request it to perform retransmission, then the STA1 retransmits the segment which is not correctly received by the AP or all segments. If none of segments are received correctly, the AP waits a PIFS and then retransmits the sounding poll frame to the STA1 to request it to retransmit all the segments. If a part of segments are not received correctly, the AP waits the SIFS and then retransmits the sounding poll frame to the STA1 to request it to retransmit the segment which is not correctly received.

### FIFTH EMBODIMENT

An AP sends a NDPA frame to an STA1, STA2 and STA3 to request each of them to perform a channel measurement and feed back a measurement result; the AP initiates a TXOP by using the NDPA frame including identifier information of the STA1, STA2 and STA3.

After sending the NDPA frame completely, the AP waits an SIFS and then sends a NDP frame. After the STA1, STA2 and STA3 receive the NDPA frame and the NDP frame, the first station STA1 in the NDPA frame waits an SIFS after receiving the NDP frame completely, and then feeds back its channel measurement information (VHT Compressed Beamforming frame) to the AP.

Given that the length of the VHT Compressed Beamforming frame of the STA1 is greater than the maximum length of an MPDU, this VHT Compressed Beamforming frame needs to be segmented. In this embodiment, the STA1 segments the VHT Compressed Beamforming frame into 5 segments which are all sent to the AP by using one A-MPDU, wherein each segment includes information for indicating the number of retained segments and whether the segment itself is a first segment.

After receiving the VHT Compressed Beamforming frame of the STA1, the AP determines that at least one segment of the VHT Compressed Beamforming frame is correctly received, then it is considered that the AP obtains a valid response frame responding to the NDPA frame, and that the TXOP is obtained successfully.

If it is determined that there is a segment is not correctly received, the AP sends a sounding poll frame to the STA1 to request it to perform retransmission, then the STA1 retransmits the segment which is not correctly received by the AP or all segments.

After receiving the TXOP, the AP continually sends the sounding poll frame to the STA2 to request it to feed back its channel measurement information. After receiving the sounding poll frame sent by the AP, the STA2 feeds back its channel measurement information (VHT Compressed Beamforming frame) to the AP.

If the length of the VHT Compressed Beamforming frame of the STA2 is greater than the maximum length of the MPDU, this VHT Compressed Beamforming frame needs to be segmented. In this embodiment, the STA2 segments the VHT Compressed Beamforming frame into 6 segments which are all sent to the AP by using one A-MPDU, wherein each segment includes information for indicating the number of retained segments and whether the segment itself is a first segment.

After receiving the VHT Compressed Beamforming frame of the STA2, the AP determines that at least one segment of the VHT Compressed Beamforming frame is correctly received, then it is considered that the AP obtains a valid response frame corresponding to the sounding poll frame.

If it is determined that there is a segment is not correctly received, the AP sends the sounding poll frame to the STA2 to request it to perform retransmission, then the STA2 retransmits the segment which is not correctly received by the AP or all segments. If none of segments are received correctly, the AP waits a PIFS and then retransmits the sounding poll frame to the STA2 to request it to retransmit all the segments. If a part of segments are not received correctly, the AP waits the SISF and then retransmits the sounding poll to the STA2 to request it to retransmit the segment which is not correctly received.

The above descriptions are only exemplary embodiments of the disclosure, rather than limit the disclosure. Any modification, equivalent substitute or improvement within spirit and principle of the disclosure will fall into the protection scope of the disclosure.

What is claimed is:

1. A method for feeding back channel measurement information, comprising:
receiving, by a receiving station, a control frame for a channel measurement from a sending station, and sending channel measurement information to the sending station;
correctly receiving, by the sending station, the channel measurement information or a part of the channel measurement information to obtain a valid response frame responding to the control frame for the channel measurement.

2. The method according to claim 1, wherein the control frame for the channel measurement comprises: an announcement frame for the channel measurement, and/or a Null Data Packet (NDP) frame, and/or a channel measurement information sounding poll frame.

3. The method according to claim 2, wherein the announcement frame is a Null Data Packet Announcement (NDPA) frame which includes identifier information of one or more receiving stations which need to perform the channel measurement; and
the NDP frame is used by the receiving station to perform the channel measurement.

4. The method according to claim 1, wherein when the control frame for the channel measurement is used to initiate a Transmission Opportunity (TXOP), and when the sending station correctly receives the channel measurement information or the part of the channel measurement information from the receiving station, the TXOP is obtained successfully.

5. The method according to claim 1, wherein the part of the channel measurement information comprises at least one segment of the channel measurement information.

6. The method according to claim 5, further comprising:
sending, by the sending station, a channel measurement information sounding poll frame to the receiving station to request the receiving station to perform retransmission when the sending station determines that all segments from the receiving station are not correctly received; and
retransmitting, by the receiving station, a segment which is not correctly received or all the segments in the channel measurement information after receiving the channel measurement information sounding poll frame.

7. The method according to claim 5, wherein the valid response frame is a channel measurement feedback report frame.

8. The method according to claim 5, wherein the sounding poll frame includes information for indicating which segment needs to be retransmitted, or indicating all segments need to be retransmitted.

9. The method according to claim 5, wherein the sending a channel measurement information sounding poll frame to the receiving station to request the receiving station to perform retransmission by the sending station comprises:
sending, by the sending station, the channel measurement information sounding poll frame to the receiving station to request the receiving station to retransmit a first segment when determining that only the first segment is not correctly received;
sending, by the sending station, the channel measurement information sounding poll frame to the receiving station to request the receiving station to retransmit a segment which is not received correctly when determining that the first segment is correctly received;
waiting, by the sending station, a Point Coordination Function (PCF) InterFrame Space (PIFS) and then sending the channel measurement information sounding poll frame to the receiving station to request the receiving station to retransmit all segments when determining that none of segments are not received correctly; and
waiting, by the sending station, a Short InterFrame Space (SIFS) and then sending the channel measurement information sounding poll frame to the receiving station to request the receiving station to retransmit the segment which is not received correctly when determining that a part of segments is not received correctly.

10. A system for feeding back channel measurement information, at least comprising a sending station and a receiving station, wherein:
the sending station is configured to send a control frame for a channel measurement to the receiving station, and to correctly receive channel measurement information or a part of the channel measurement information from the receiving station to obtain a valid response frame responding to the control frame for the channel measurement; wherein the part of the channel measurement information comprises at least one segment of the channel measurement information; and
the receiving station is configured to receive the control frame for the channel measurement from the sending station, and to send the channel measurement information to the sending station.

11. The system according to claim 10, wherein the sending station is further configured, when all segments from the receiving station are not correctly received, to send a channel measurement information sounding poll frame to the receiving station to request the receiving station to perform retransmission; and
the receiving station is correspondingly configured to receive the channel measurement information sounding poll frame, and to retransmit a segment which is not correctly received or all the segments in the channel measurement information.

12. The system according to claim 10, wherein when the control frame for the channel measurement is used to initiate a Transmission Opportunity (TXOP), and when the sending station correctly receives the channel measurement information or the part of the channel measurement information from the receiving station, the TXOP is obtained successfully.

13. The system according to claim 10, 11, or 12, wherein the sending station is an Access Point (AP), and the receiving station is a STAtion (STA) which is of a non-AP; and
a number of the receiving station is one or more.

14. The method according to claim 2, wherein the part of the channel measurement information comprises at least one segment of the channel measurement information.

15. The method according to claim 3, wherein the part of the channel measurement information comprises at least one segment of the channel measurement information.

16. The method according to claim 4, wherein the part of the channel measurement information comprises at least one segment of the channel measurement information.

17. The method according to claim 14, further comprising:
sending, by the sending station, a channel measurement information sounding poll frame to the receiving station to request the receiving station to perform retransmission when the sending station determines that all segments from the receiving station are not correctly received; and
retransmitting, by the receiving station, a segment which is not correctly received or all the segments in the channel measurement information after receiving the channel measurement information sounding poll frame.

18. The method according to claim 15, further comprising:
sending, by the sending station, a channel measurement information sounding poll frame to the receiving station to request the receiving station to perform retransmission when the sending station determines that all segments from the receiving station are not correctly received; and
retransmitting, by the receiving station, a segment which is not correctly received or all the segments in the channel measurement information after receiving the channel measurement information sounding poll frame.

19. The method according to claim 16, further comprising:
sending, by the sending station, a channel measurement information sounding poll frame to the receiving station to request the receiving station to perform retransmission when the sending station determines that all segments from the receiving station are not correctly received; and
retransmitting, by the receiving station, a segment which is not correctly received or all the segments in the channel measurement information after receiving the channel measurement information sounding poll frame.

20. The method according to claim 14, wherein the valid response frame is a channel measurement feedback report frame.

21. The method according to claim 15, wherein the valid response frame is a channel measurement feedback report frame.

22. The method according to claim 16, wherein the valid response frame is a channel measurement feedback report frame.

23. The method according to claim 14, wherein the sounding poll frame includes information for indicating which segment needs to be retransmitted, or indicating all segments need to be retransmitted.

24. The method according to claim 15, wherein the sounding poll frame includes information for indicating which segment needs to be retransmitted, or indicating all segments need to be retransmitted.

25. The method according to claim 16, wherein the sounding poll frame includes information for indicating which segment needs to be retransmitted, or indicating all segments need to be retransmitted.

26. The method according to claim 14, wherein the sending a channel measurement information sounding poll frame to the receiving station to request the receiving station to perform retransmission by the sending station comprises:
sending, by the sending station, the channel measurement information sounding poll frame to the receiving station to request the receiving station to retransmit a first segment when determining that only the first segment is not correctly received;
sending, by the sending station, the channel measurement information sounding poll frame to the receiving station to request the receiving station to retransmit a segment which is not received correctly when determining that the first segment is correctly received;
waiting, by the sending station, a Point Coordination Function (PCF) InterFrame Space (PIFS) and then sending the channel measurement information sounding poll frame to the receiving station to request the receiving station to retransmit all segments when determining that none of segments are not received correctly; and
waiting, by the sending station, a Short InterFrame Space (SIFS) and then sending the channel measurement information sounding poll frame to the receiving station to request the receiving station to retransmit the segment which is not received correctly when determining that a part of segments is not received correctly.

27. The method according to claim 15, wherein the sending a channel measurement information sounding poll frame to the receiving station to request the receiving station to perform retransmission by the sending station comprises:
sending, by the sending station, the channel measurement information sounding poll frame to the receiving station to request the receiving station to retransmit a first segment when determining that only the first segment is not correctly received;
sending, by the sending station, the channel measurement information sounding poll frame to the receiving station to request the receiving station to retransmit a segment which is not received correctly when determining that the first segment is correctly received;
waiting, by the sending station, a Point Coordination Function (PCF) InterFrame Space (PIFS) and then sending the channel measurement information sounding poll frame to the receiving station to request the receiving station to retransmit all segments when determining that none of segments are not received correctly; and
waiting, by the sending station, a Short InterFrame Space (SIFS) and then sending the channel measurement information sounding poll frame to the receiving station to request the receiving station to retransmit the segment which is not received correctly when determining that a part of segments is not received correctly.

28. The method according to claim 16, wherein the sending a channel measurement information sounding poll frame to the receiving station to request the receiving station to perform retransmission by the sending station comprises:
sending, by the sending station, the channel measurement information sounding poll frame to the receiving station to request the receiving station to retransmit a first segment when determining that only the first segment is not correctly received;
sending, by the sending station, the channel measurement information sounding poll frame to the receiving station to request the receiving station to retransmit a segment which is not received correctly when determining that the first segment is correctly received;
waiting, by the sending station, a Point Coordination Function (PCF) InterFrame Space (PIFS) and then sending the channel measurement information sounding poll frame to the receiving station to request the receiving station to retransmit all segments when determining that none of segments are not received correctly; and
waiting, by the sending station, a Short InterFrame Space (SIFS) and then sending the channel measurement information sounding poll frame to the receiving station to request the receiving station to retransmit the segment which is not received correctly when determining that a part of segments is not received correctly.

29. The system according to claim 11, wherein the sending station is an Access Point (AP), and the receiving station is a STAtion (STA) which is of a non-AP; and
a number of the receiving station is one or more.

30. The system according to claim 12, wherein the sending station is an Access Point (AP), and the receiving station is a STAtion (STA) which is of a non-AP; and
a number of the receiving station is one or more.
